(19) United States
(12) Patent Application Publication
(10) Pub. No.: US 2009/0277248 A1
(43) Pub. Date: Nov. 12, 2009

(54) METHOD TO DETERMINE GAS LEAKAGE FROM UNDERGROUND PIPELINES

(75) Inventors: Alexander Petrovich Skibin, Moscow (RU); Vladimir Vasilievich Tertychnyi, Edmonton (CA); Alexander Nikolaevich Shandrygin, Moscow (RU); Valery Vasilievich Shako, Domodedovo (RU)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: Schlumberger Technology Corporation, Cambridge, MA (US)

(21) Appl. No.: 12/344,937

(22) Filed: Dec. 29, 2008

(30) Foreign Application Priority Data
Dec. 29, 2007 (RU) 2007148847

(51) Int. Cl. G01M 3/28

(52) U.S. Cl. 73/40.5 R

(57) ABSTRACT

Method to determine the point of the gas leak from the buried pipeline located in the ditch under the soil, providing positioning at least one fiber-distributed temperature transmitter in the soil over the pipeline; the fiber-distributed temperature transmitter's readings allow to determine the leak point presence and location; the method is characterized by the fact that the fiber-distributed temperature transmitter is located above the pipeline surface; in the ground, between the pipeline and the transmitter or over the transmitter a shield is mounted which deflects the gas flow (in case of leakage) in the upper central part of the ditch adjacent to the transmitter and preventing the gas flow to the ditch peripheral areas located far away from the transmitter; the temperature is measured continuously and by the temperature drop the gas leak and its location is determined.

### BACKGROUND OF INVENTION

1. Field of Invention

The invention is related to instrumentation used to monitor gas-containing equipment tightness and, more specifically, to equipment for remote gas-leakage detection on buried main pipeline.

2. Background of the Invention

Pipeline visual inspection methods consisting in periodic inspection of the soil along the pipeline route to detect leaks are known (see e.g., Ionin D. A., Yakovlev Ye. I. Present-Day Methods of Main Gas Pipeline Diagnosis.—Leningrad: Nedra, 1987.—pp. 69-71). But these methods are rather time-consuming and are not always feasible due to climatic and landscape conditions.

Leak-detection methods consisting in passing different devices with built-in data collection, processing and storage devices inside the pipeline being monitored are also known (see e.g., RU 15518 U1). Drawbacks of these methods are equipment complexity, necessity of special-purpose equipment and low sensitivity to low- and medium-range pipeline gas leaks.

The closest prototype of the invention claimed is the method of buried pipeline gas leakage localization describe in U.S. Patent Application No. 2004/0154380. The method above also provides the application of a fiber-distributed temperature transmitter laid directly on the pipeline pipe and covered with a shield. This method's drawback lies in the fact that if the shield is damaged in case of the pipeline rupture with major gas losses the detection system operation efficiency reduces dramatically due to gas filtration around the shielded pipeline by-passing the fiber-distributed temperature transmitter. Besides, low gas flow-rate caused by the pipeline rupture results in the detection system low efficiency due to the intensive heat-exchange between the filtered leak-gas flow and the main gas flow across the pipe wall.

### DETAILED DESCRIPTION OF THE PREFERRED EMBODIMENTS

Engineering result attained in case of the invention implementation consists in ensuring efficient pipeline gas break-through localization regardless of the break-through point azimuthal location, using one fiber-distributed temperature transmitter.

This engineering result is attained due to the fact that in the ditch above the buried pipeline and parallel to its axis at least one fiber-distributed temperature transmitter equipped with a shield that in case of gas leakage deflects the gas flow from the pipeline to the ditch's upper central part adjacent to the transmitted and preventing the gas flow in the ditch's peripheral areas located far away from the transmitter; simultaneously the temperature continuous measurement is conducted and the temperature drop is the indicator of the leakage presence and location. The shield may be located between the fiber-distributed temperature transmitter and the pipeline or over the fiber-distributed temperature transmitter. The shield may be made as a metal or plastic sheet punched in the central part adjacent to the pipeline vertical axis. The shield may also be made of minimum two metal or plastic sheets located in the ditch with a gap in which the transducer is located; the sheets prevent the gas flow into the ditch's peripheral areas.

Another option of the invention implementation provides zigzag location of the fiber-distributed temperature transmitter in the horizontal plane above the pipeline.

The fiber-distributed temperature transmitter must be located 20-80 cm above the pipeline. Exact pipeline-to-transmitter distance is determined depending on the pipeline diameter (directly proportional to the diameter).

The method of natural and other gases leakage localization using continuous temperature measurement is based on the idea of applying heat effect of the significant pressure drop in the flow of the gas flowing out of the pipeline. The temperature change in the gas or liquid flow resulting from the pressure drop is known as Joule-Thomson effect. In steady-state approximation the temperature drop may be calculated as Joule-Thomson coefficient times the pressure drop value. In case of natural gas blends this corresponds to the cooling with the characteristic value of Joule-Thomson coefficient around several degrees per one megapascal pressure drop. In this case complete temperature drop between the pipe flow and the leak-gas flow in the ditch may reach 100 degrees Centigrade. This temperature drop may be measured using a fiber-distributed temperature transmitter laid above the pipeline for convenience reasons (to facilitate the in-ditch fiber-distributed temperature transmitter).

Usually the temperature permeability of the material filling the pipeline ditch may be considered significantly higher than the surrounding soil permeability. The gas leakage may originate both in the pipeline lower segment (because the through damage or cracks may result from corrosion which is most likely in the ditch moisture accumulation areas) and the upper segment (where the possibility of the pipeline mechanical damage during its laying into the ditch is high). In both the cases due to the ditch filler's higher permeability compared with undisturbed soil outside the ditch, the most likely gas flow direction from the leakage location is upwards—towards the surface across the filler. The complete gas flow is distributed along the ditch cross-section. For this reason in case of low- and medium-range gas leakages the local gas and filler cooling in the fiber-distributed temperature transmitter area may be below the transmitter measurement system sensitivity threshold.

Locating the punched shield made of a metal or plastic sheet between the pipeline and the fiber-distributed temperature transmitter or above the transmitter will enable concentrating the cold gas flow in the ditch upper central part. Punched holes in the shield are made in such a way that ensures gas flow to the surface across the ditch central area and block the gas flow across the ditch peripheral areas. Instead of punched sheets for the same purpose it is possible to use a pair of sheets with a gap between them laid near the pipeline vertical axis; in the gap the transmitter is located,—in this case the sheets prevent the gas flow into the ditch peripheral areas. The fiber-distributed temperature transmitter may also be attaché to the shield.

Therefore, the punched shield or sheets with the gap between them improve the temperature measurement system sensitivity to the gas flow-rate due to the heat effect concentration in the temperature measurement area.

Zigzag location of the fiber-distributed temperature transmitter in the horizontal plane above the buried gas pipeline allows increasing the integrated temperature reduction in the temperature averaging range which results in the improved effective special resolution with reference to the specific application case. Predominant gas flow direction from the leakage location is upwards, towards the ground surface, mostly across the filler with the gas-flow divergence angle of about 90 degrees. The complete length along the pipeline horizontal axis on which the filler is cooled down in the degree sufficient to be recorded using the fiber-distributed temperature transmitter in terms of the value about 3-4 diameters of the pipeline, considering the intensive heating of the cooled down volume at the expense of the gas flow inside the pipeline. Temperature monitoring along the pipeline implies a long measurement distance (10-30 km) with the increased temperature averaging spatial range to the value of about 10 meters (compared with shorter temperature measurement distances using a fiber-distributed temperature transmitter). Therefore in cases of low- and medium-range gas-leak flow the average-integrated temperature drop value in the averaging range may be below the transmitter sensitivity threshold, considering the temperature disturbances caused by other factors, not related to the pipeline integrity damage.

Zigzag location of the fiber-distributed temperature transmitter as a wavy line in the horizontal plane allows increasing the length of the fiber-distributed temperature transmitter area subject to reduced temperature caused by the cold gas flow from the pipeline leak. The complete number of fiber-distributed temperature transmitter's bends per pipeline length unit is limited by the complete admissible fiber-distributed temperature transmitter length. Therefore, the bends' number and across-the-ditch width may be calculated based on the required spatial resolution and admissible total length cable.

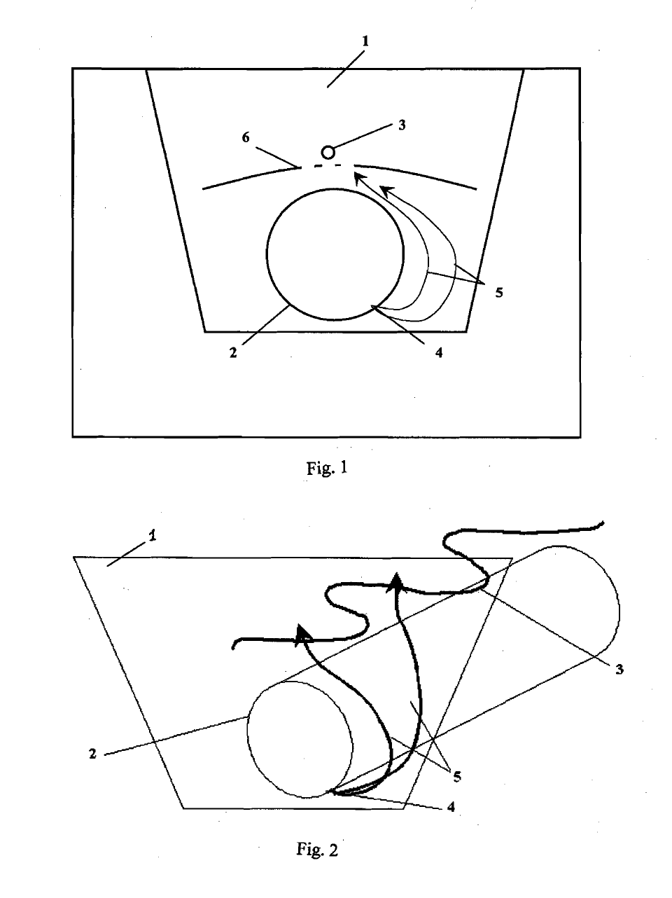

The invention is clarified with a drawing where FIG. 1 shows fiber-distributed temperature transmitter and shield layout in the pipeline ditch. FIG. 2—shows zigzag location of fiber-distributed temperature transmitter in the pipeline ditch.

In ditch 1 with highly permeable filler over pipeline 2 at the distance of 20-80 cm parallel to its axis at least one standard fiber-distributed temperature transmitter 3 is located. In case of leakage the gas flow direction from leakage point 4 is shown with arrows 5. In accordance with FIG. 1, between transmitter 3 and pipeline 2 shield 6 is mounted which directs the pipeline gas flow from the leakage point 4 to the ditch upper central area adjacent to transmitter 3 and preventing gas flow to the ditch peripheral areas located far away from transmitter 3. Shield 6 ensures gas flow concentration from the leakage point in the area where the fiber-distributed temperature transmitter 3 is located. To ensure flow concentration in the transmitter location area shield 6 must have punched holes in the central part adjacent to the pipeline vertical axis. Shield 6 may also be made as minimum two metal or plastic sheets located in ditch 1 with a gap in which transmitter 3 is located. The temperature is measured continuously; and by the temperature drop the gas leak and its location is determined.

Due to the holes in shield 6 near the pipeline vertical axis the gas flow is blocked along the ditch periphery far away from the fiber-distributed temperature transmitter 3 and the gas flow is routed via the holes near transmitter 3. Cold gas flow concentration allows a significant increase of the temperature drop near the fiber-distributed temperature transmitter which improves the system sensitivity.

In accordance with FIG. 2, fiber-distributed temperature transmitter 3 is located zigzag-like in the horizontal plane over pipeline 2. Gas flow direction from leak point 4 is shown with arrows 5. The predominant gas flow direction from the leak point is upwards, to the ground surface, mostly across the filler with gas flow divergence angle of about 90 degrees. The temperature is measured continuously; and by the temperature drop the gas leak and its location is determined.

Zigzag-like location of fiber-distributed temperature transmitter 3 allows increasing the length of the transmitter section subject to reduced temperature caused by cold gas flow 5 from leak point 4 in pipeline 2 which improves the system sensitivity.

What is claimed is:

1. A method to determine the point of the gas leak from the buried pipeline located in the ditch under the soil, providing positioning at least one fiber-distributed temperature transmitter in the soil over the pipeline; the fiber-distributed temperature transmitter's readings allow to determine the leak point presence and location; the method is characterized by the fact that the fiber-distributed temperature transmitter is located above the pipeline surface; in the ground, between the pipeline and the transmitter or over the transmitter a shield is mounted which deflects the gas flow (in case of leakage) in the upper central part of the ditch adjacent to the transmitter and preventing the gas flow to the ditch peripheral areas located far away from the transmitter; the temperature is measured continuously and by the temperature drop the gas leak and its location is determined.

2. A method to determine the point of the gas leak from the buried pipeline according to claim 1 characterized by the fact that the shield is made as a metal or plastic sheet with punched holes in the central part adjacent to the pipeline vertical part.

3. A method to determine the point of the gas leak from the buried pipeline according to claim 1 characterized by the fact that the shield is made at least two metal or plastic sheets located in the ditch with a gap between them in which the transmitter is located and preventing the gas flow in the ditch peripheral areas.

4. A method to determine the point of the gas leak from the buried pipeline, providing positioning at least one fiber-distributed temperature transmitter in the soil over the pipeline; the fiber-distributed temperature transmitter's readings allow to determine the leak point presence and location, characterized by the fact that the fiber-distributed temperature transmitter is positioned zigzag-like in the horizontal plane over the pipeline surface.
